(19) United States
(12) Patent Application Publication
(10) Pub. No.: US 2023/0004898 A1
(43) Pub. Date: Jan. 5, 2023

(54) PROSPECTIVE FAULT ADAPTATION FOR PROJECT MANAGEMENT

(71) Applicant: IRIS Technology Solutions, S.L., Barcelona (ES)

(72) Inventors: Colm Digby, Sant Esteve Sesrovires (ES); Oonagh Claire Mc Nerney, Sant Esteve Sesrovires (ES); David Francis Nettleton Ford, Barcelona (ES)

(73) Assignee: IRIS Technology Solutions, S.L., Barcelona (ES)

(21) Appl. No.: 17/667,693

(22) Filed: Feb. 9, 2022

(30) Foreign Application Priority Data
Jul. 2, 2021 (ES) P202130623

(51) Int. Cl. G06Q 10/06

(52) U.S. Cl. CPC G06Q 10/06312; G06Q 10/063118; G06Q 10/06313; G06Q 10/06315

(57) ABSTRACT

Prospective fault adaptation for project management includes generating a project in a project management system according to a timeline of different overlapping tasks and interdependent, a cost to completion and a count of human resources required to complete the tasks at or below the cost to completion. An indication of a prospective fault condition is received in connection with a task in the project. The prospective fault is then quantified and an adjustment computed to the timeline, cost to completion, count of human resources or scope. The adjustment is compared to a threshold value indicative of an acceptable project outcome. Finally, a visualization of the project is generated in the project management system including the flag and an alert representative of the comparison.

### BACKGROUND OF THE INVENTION

### Field of the Invention

The present invention relates to the technical field of project management and more particularly to fault management during project management.

### Description of the Related Art

Project management refers to the process of defining team goals and tasks directed to achieving the defined goals in a coherent way over a period of time during which the tasks are scheduled. The defined goals sum to a project such that upon the completion of all of the goals, the project will have come to fruition. For small projects, project management can be as simple as dynamically deciding with a mental or physical checklist which individuals in a group will perform which tasks so as to complete the project. For larger projects, the number of participants and tasks can become too numerous to track in the mind of a single project manager. For those larger projects, a project management tool is required.

A project management tool is a computer program that permits an administrator to define a file for a project, to specify the tasks to achieve the project and to group different tasks according to phases of the project. As well, the project management tool permits the administrator to define a set of participants for the project and to assign different ones of the tasks to different ones of the participants. Modern sophisticated project management tools go so far as to incorporate as part of the tool, electronic messaging, shared document management and calendaring and scheduling integration. As well, most modern project management tools provide a visualization of the defined project including its constituent tasks, the timeline on which the tasks are to be completed. Further, some project management tools provide a visual indication when a task has missed its deadline and is thus likely to disrupt the ability of the project to be timely completed.

Even still, late, uncompleted task management is a reactionary feature of the modern project management tool. When a task is not completed, once the task has entered “default” a visualization of the project can readily highlight the troubled task through any number of decorators including highlighting and flagging. But, until a task has entered a default state having passed its deadline uncompleted a project manager may not be made readily aware. Particularly, for a project of hundreds if not thousands of tasks, noticing an impending default of a task is difficult in so far as the project manager would be required to proactively inspect the state of the task without prompting by the project management system. Accordingly, a suboptimal outcome results.

### BRIEF SUMMARY OF THE INVENTION

Embodiments of the present invention address technical deficiencies of the art in respect to fault management during project management. To that end, embodiments of the present invention provide for a novel and non-obvious method for prospective fault adaptation during project management. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a prospective fault adaptation method for project management includes generating a project in a project management system according to a timeline of different overlapping tasks, a cost to completion and a count of human resources required to complete the tasks at or below the cost to completion. Different ones of the tasks can be independent of one another, or dependent upon others of the tasks based upon the necessity of completion of one of the tasks in support of another of the tasks. Different ones of the tasks also can be dependent upon others of the tasks based upon a sharing of human resources required for the completion of each of the dependent tasks. As well, different ones of the tasks can be dependent upon others of the tasks based upon a scheduled overlapping of the timing of performance of the dependent tasks. In all instances, a scope can be defined as a collection of different ones of the tasks.

The method also includes receiving an indication of a prospective fault condition in connection with one of the tasks in the project, quantifying the prospective fault and computing an adjustment to any of the timeline, cost to completion and count of human resources in consequence of the prospective fault. Optionally, an adjustment in the scope of the project can be computed based upon a perceived addition or removal from the scope of one or more tasks in the project. Then, the adjustment is compared to a bounded range of acceptable values indicative of an acceptable project outcome. As such, a visualization of the project can be generated in the project management system including a flag representative of the prospective fault and including the comparison.

In one aspect of the embodiment, the quantification of the prospective fault can be compared with a known past quantification and the quantification can be adjusted to be consistent with the known past quantification. In another aspect of the embodiment, an accuracy metric is retrieved for the one of the end users and the quantification adjusted based upon the retrieved accuracy.

In yet another aspect of the embodiment, an indication is received from the one of the end users of a resolution of the prospective fault and an actual impact is computed of the prospective fault at a time of the resolution based upon an additional amount of time required to complete the one of the tasks. Then, the known past quantification is set as the additional amount of time. In even yet another aspect of the embodiment, an indication is received from the one of the end users of a resolution of the prospective fault, an actual impact of the prospective fault is then computed at a time of the resolution based upon an additional cost required to complete the one of the tasks and the known past quantification is set as the additional cost. Finally, in even yet another aspect of the embodiment, an indication is received of a resolution of the prospective fault and an actual impact is computed of the prospective fault at a time of the resolution based upon an additional count of human resources required to complete the one of the tasks. Then, the known past quantification is set as the additional count of human resources.

In another embodiment of the invention, a data processing system is adapted for prospective fault adaptation for project management. The system includes a host computing platform having one or more computers, each with memory and one or processing units including one or more processing cores. The system also includes a fault adaptation module. The module includes computer program instructions enabled while executing in the memory of at least one of the processing units of the host computing platform to generate a project in a project management system according to a timeline of different overlapping tasks, either dependent or interdependent, including potentially interdependent tasks, a count of human resources required to complete the tasks, a time required to complete the tasks, a cost computed as a function of the count and time, as well as one or more defined scopes.

The program instructions additionally are enabled to receive an indication of a prospective fault condition in connection with one of the tasks in the project, to quantify the prospective fault and compute an adjustment to any of the timeline, cost to completion and count of human resources, and optionally a corresponding scope. In consequence of the prospective fault, the program instructions are yet further enabled to compare the adjustment to a threshold value indicative of an acceptable project outcome and to generate a visualization of the project in the project management system including a flag representative of the prospective fault and including the comparison.

In yet another embodiment of the invention, a computing device is provided that has a non-transitory computer readable storage medium having program instructions stored therein. The instructions are executable by at least one processing core of a processing unit to cause the processing unit to perform a method for prospective fault adaptation for project management. The method includes the generation of a project in a project management system according to a timeline of different overlapping tasks, a cost to completion and a count of human resources required to complete the tasks at or below the cost to completion, and optionally, a scope incorporating one or more of the tasks. The method also includes the receipt of an indication of a prospective fault condition in connection with one of the tasks in the project.

The method further includes the quantification of the prospective fault and the computation of an adjustment to one or more of the timeline, cost to completion and count of human resources, as well as scope, in consequence of the prospective fault. The method even yet further includes a comparison of the adjustment to a threshold value indicative of an acceptable project outcome. Finally, the method includes a visualization of the project in the project management system including a flag representative of the prospective fault and including the comparison.

In this way, the technical deficiencies of the conventional project management and task default are overcome owing to the ability of the invention to not only forecast an impending default of a task, but also to quantify the nature of the default and to indicate a resulting impact of the default.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of prospective fault adaptation for project management;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for prospective fault adaptation for project management. In accordance with an embodiment of the invention, a project is defined in a project management system to include different tasks, each scheduled for initiation and completion over a period of time with some of the tasks overlapping others of the tasks and some of tasks being grouped together to form different scopes, with some of the tasks being interdependent upon others of the tasks. Each of the tasks as well as each of the scopes includes a scheduled duration of time to perform the task and a count of human resources required to complete the task at or below the cost to completion. As such, a cost to completion of the task is associated with each task as a function of the duration of time and count of resources.

For each of the tasks, a range of values can be defined for one or more attributes of the tasks, such as the scheduled duration and count of human resources assigned to each of the tasks. The range of values can include an upper bound and a lower bound such that a fault condition arises when a contemporaneously observed value for either or both of the scheduled duration and count of human resources falls outside of the defined range. In one aspect of the embodiment, a fault condition arises when a monitored value is detected to fall outside of a defined range. However, in another aspect of the embodiment, the process can be manual wherein access control is provided to a list of end users managing at least one of the tasks. Thereafter, one of the end users in the list indicates a prospective fault condition in connection with one of the tasks in the project by flagging the suspect task, or possibly one of the scopes of tasks of the project by flagging the suspect scope of tasks.

In response, the prospective fault is quantified, and an adjustment computed in respect either to the timeline, the cost to completion or the count of human resources in consequence of the prospective fault, or the addition to or removal of one or more tasks from a flagged one of the scopes. The computed adjustment is then compared to a threshold value that indicates an acceptable project outcome. Finally, a visualization of the project can be generated within the project management system which includes a flag representative of the prospective fault and including the comparison.

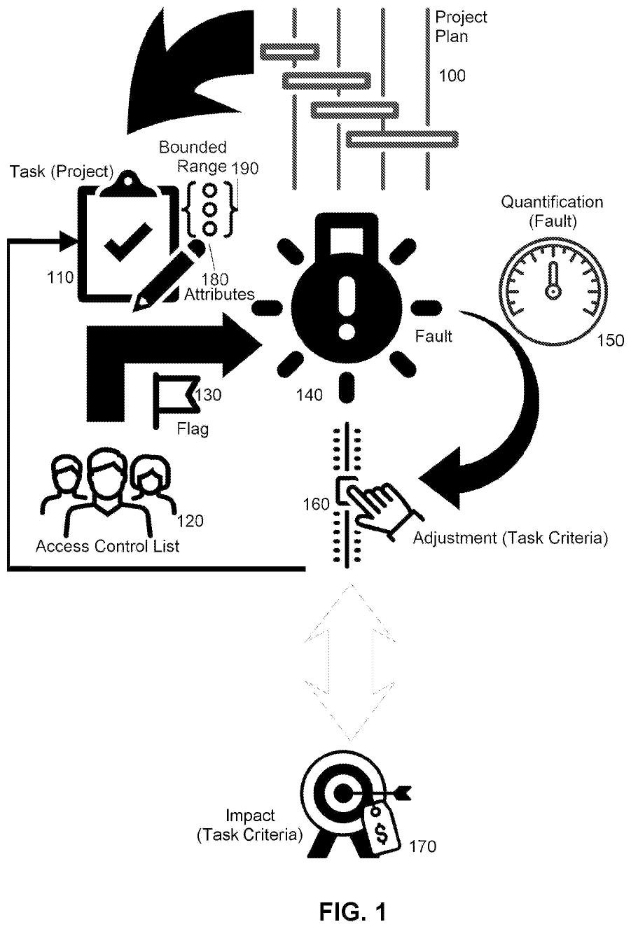

In illustration of one aspect of the embodiment, FIG. 1 pictorially shows a process of prospective fault adaptation for project management. As shown in FIG. 1, a project plan 100 is defined to include multiple different tasks of varying durations, in some cases overlapping one another, and in some cases being interdependent upon one another, so as to result in a project goal upon completion of all of the tasks. Each of the tasks 110 has one or more criteria 180 such as a duration of time to completion, or a count of human resources. As well, each of the criteria 180 includes a bounded range 190 of acceptable values from minimum to maximum, outside of which a corresponding one of the criteria 180 is considered to be in fault. Consequently, a selected one of the tasks 110 receives an assignment of a flag 130 when a prospective fault condition 140 arises when one or more of the criteria 180 of one of the tasks 110, or a scope incorporating the selected one of the tasks 110, has an observed value for a corresponding one of the criteria 180 exceeds the bounded range 190 specified for the corresponding one of the criteria 180 of. the selected one of the tasks 110.

Alternatively, an access control list 120 of different authorized end users is established such that one of the end users in the list 120 manually selects a task 110 of the project plan 100 and manually assigns a flag 130 thereto indicating a prospective fault condition 140 breaching a criteria specified for the task 110. The breached criteria can include, for instance, an unlikelihood that the task 110 will be completed by an assigned deadline, or an unlikelihood that the task 110 will be completed utilizing an allotted number of human resources. In either circumstance, the breached criteria results in an unlikelihood that the selected one of the tasks 110 will be completed within a budgeted amount of cost,

In response to the declaration of the fault condition 140 through the establishment of the flag 130, the fault condition 140 can be quantified into a value 150 indicative of a quantitative impact upon the criteria of the task 110 such as delay in completion of the task 110 by a specified deadline, an excess cost beyond a budget specified for the task 110 to be incurred in completing the task 110, or an excess of required human resources beyond an allocated quantity of human resources specified for the task 110 to be utilized in completing the task 110. An adjustment 160 is thus specified for the criteria of the task to account for the quantified value 150, such as a change in a deadline, budget or allocated resources.

The adjustment 160 can be manually specified by the end user of the access control list 120, or automatically in reference to a past adjustment selected for the fault condition 140. In the event of a manually specified adjustment 160, an identity of the end user can be processed to select a weight to the adjustment 160 based upon past adjustments recommended by the end user and a resulting accuracy of those adjustments. In this regard, the past adjustments can be presented in a user interface in a selectable manner sorted by accuracy so that one of the adjustments can be selected for finalization as the adjustment 160. Once the adjustment 160 has been finalized, the impact 170 of the adjustment 160 to the criteria 180 of the project plan 100 can be assessed and compared to a bounded range 170 defined for the criteria 180 of the selected one of the tasks 110. To the extent that the impact 170 of the adjustment 160 upon the criteria 180 places the criteria 180 back within the bounded range 190, the adjustment to the selected one of the tasks 110 is applied to the criteria 180 of the selected one of the tasks 110.

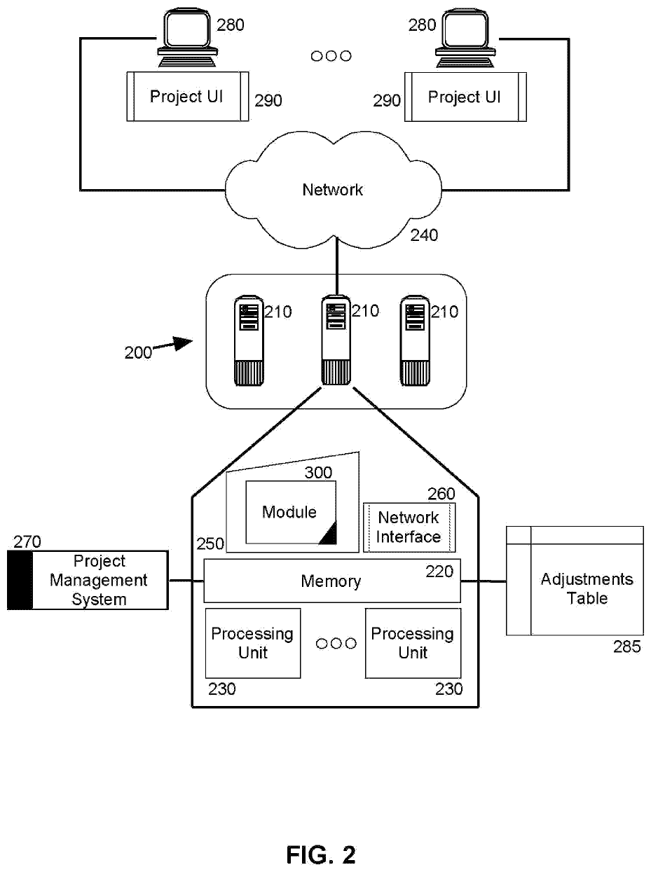

Aspects of the process described in connection with FIG. 1 can be implemented within a data processing system. In further illustration, FIG. 2 schematically shows a data processing system adapted to perform prospective fault adaptation for project management. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

A project management system 270 executes in the memory 220 of the host computing platform 200. The project management system 270 is enabled to generate a project plan of different tasks each specified according to specific criteria and to manage access to the tasks of the project plan by different end users by way of different associated computing clients 280 each supporting an instance of a user interface 290 to the project management system 270. Optionally, the project management system 270 also is enabled to define an access control list in the memory 220 of different ones of the end users empowered to apply flags to different ones of the tasks upon recognition of a fault condition.

To that end, notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for prospective fault adaptation for project management on behalf of the ones of the end users of the access control list.

Specifically, the program instructions during execution receive a directive, optionally by one of the end users of the access control list, to flag a selected task of a project plan for a prospective fault condition. The program instructions then receive a quantification of the prospective fault condition and the program instructions lookup in an adjustments table 285 in the memory 220 of the host computing platform 200, a past adjustment to the criteria of the selected task, such as a change in deadline, change in budget or change in allocation of human resources. An impact of the adjustment upon the criteria of the project plan is then predicted and compared to a bounded range of values for the criteria, such as a range of dates leading to a latest possible deadline, a range of budget from minimum to maximum including a target budget, or a range of allocations of human resources ranging from minimum headcount to maximum headcount.

To the extent that the impact of the adjustment does not exceed the bounded range, the program instructions apply the adjustment to the criteria of the selected task and the flag as applied to the selected task is updated to indicate the adjustment, the impact of the adjustment upon the criteria of the project plan and a comparison of the impact to the bounded range defined for the project plan to ensure that the adjustment places the impact within the bounded range. Otherwise, the adjustment is rejected.

Optionally, at any time one of the end users of the access control list can select a flagged task and clear the flag. In response, an actual impact to the criteria of the selected task can be measured at a time of the end user clearing the flag. As such, an adjustment is written to the adjustment table 285 accounting for the actual impact for future use. In this regard, the actual impact can be an actual extension to the deadline experienced at the time of clearing the flag, an actual cost beyond the budget of the criteria of the task experienced at the time of clearing the flag, or an actual number of additionally human resource hours consumed beyond a specified number of the criteria of the task at the time of clearing the flat.

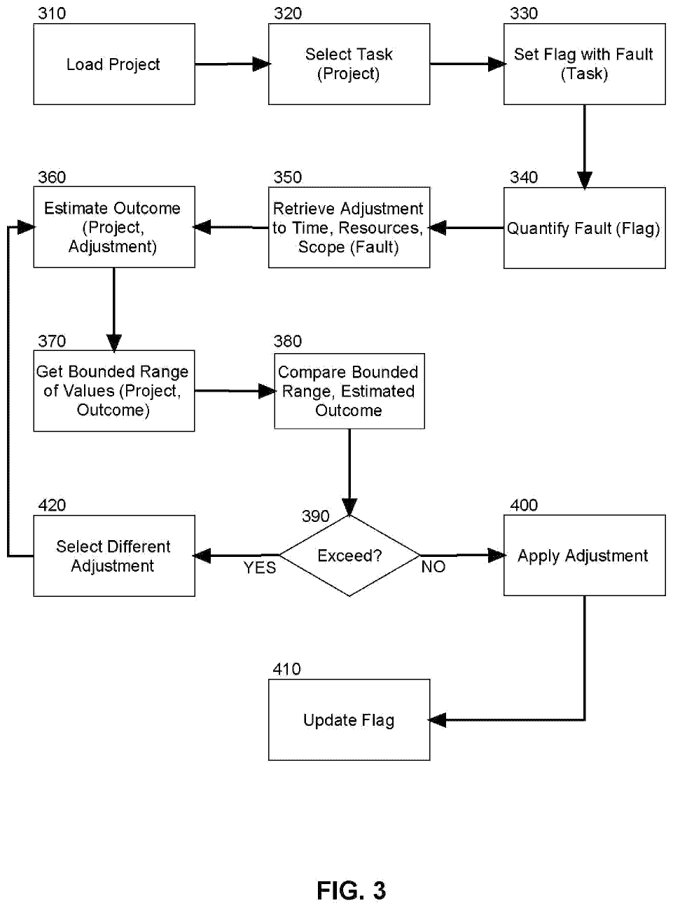

In further illustration of an exemplary operation of the module, FIG. 3 is a flow chart illustrating one of the aspects of the process of FIG. 1. Beginning in block 310 a project plan is loaded into memory of a computer as part of a project management system. In block 320, a task of the project plan is selected to receive a flag in consequence of a perceived prospective fault condition. Consequently, in block 330 a flag is set for the selected task and, in block 340, the prospective fault condition is quantified. Once the prospective fault condition has been quantified, the quantification can be used to locate from a table, an adjustment resulting from the prospective fault condition.

Upon retrieving the adjustment, in block 360, an impact upon the project plan of applying the adjustment to the selected task is estimated and a bounded range of values for the criteria of the project plan is retrieved in respect to the impact caused by the adjustment to the criteria of the selected task. Then, in block 380 the bounded range of values is compared to the impact in order to determine, in decision block 390 whether or not the impact exceeds the bounded range of values. If so, in block 420 a different adjustment is selected. But otherwise, in block 400 the adjustment is applied to the criteria of the selected task and the flag is updated in block 410 to account for the adjustment and the comparison of the impact of the adjustment upon the criteria of the project plan and the bounded range of values for the criteria of the project plan.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A prospective fault adaptation method for project management comprising
generating a project in a project management system according to a timeline of different overlapping tasks, a cost to completion and a count of human resources required to complete the tasks at or below the cost to completion;
receiving an indication of a prospective fault condition in connection with one of the tasks in the project;
quantifying the prospective fault and computing an adjustment to one of the timeline, cost to completion and count of human resources in consequence of the prospective fault;
comparing the adjustment to a threshold value indicative of an acceptable project outcome; and,
generating a visualization of the project in the project management system including a flag representative of the prospective fault and including the comparison.

2. The method of claim 1, further comprising:
comparing the quantification of the prospective fault with a known past quantification; and,
adjusting the quantification to be consistent with the known past quantification.

3. The method of claim 1, further comprising;
retrieving an accuracy metric for the one of the end users; and,
adjusting the quantification based upon the retrieved accuracy.

4. The method of claim 2, further comprising:
receiving from the one of the end users an indication of a resolution of the prospective fault;
computing an actual impact of the prospective fault at a time of the resolution based upon an additional amount of time required to complete the one of the tasks; and,
setting the known past quantification as the additional amount of time.

5. The method of claim 2, further comprising:
receiving from the one of the end users an indication of a resolution of the prospective fault;
computing an actual impact of the prospective fault at a time of the resolution based upon an additional cost required to complete the one of the tasks; and,
setting the known past quantification as the additional cost.

6. The method of claim 2, further comprising:
receiving from the one of the end users an indication of a resolution of the prospective fault;
computing an actual impact of the prospective fault at a time of the resolution based upon an additional count of human resources required to complete the one of the tasks; and,
setting the known past quantification as the additional count of human resources.

7. The method of claim 2, further comprising:
receiving from the one of the end users an indication of a resolution of the prospective fault;
computing an actual impact of the prospective fault at a time of the resolution based upon a change in composition of a corresponding scope of the project; and,
setting the known past quantification as the change in the scope of the project.

8. A data processing system adapted for prospective fault adaptation for project management, the system comprising:
a host computing platform comprising one or more computers, each with memory and one or processing units including one or more processing cores; and,
a fault adaptation module comprising computer program instructions enabled while executing in the memory of at least one of the processing units of the host computing platform to perform:
generating a project in a project management system according to a timeline of different overlapping tasks, a cost to completion and a count of human resources required to complete the tasks at or below the cost to completion;
receiving an indication of a prospective fault condition in connection with one of the tasks in the project;
quantifying the prospective fault and computing an adjustment to one of the timeline, cost to completion and count of human resources in consequence of the prospective fault;
comparing the adjustment to a threshold value indicative of an acceptable project outcome; and,
generating a visualization of the project in the project management system including a flag representative of the prospective fault and including the comparison.

9. The system of claim 8, wherein the computer program instructions are further enabled to perform:
comparing the quantification of the prospective fault with a known past quantification; and,
adjusting the quantification to be consistent with the known past quantification.

10. The system of claim 8, wherein the computer program instructions are further enabled to perform:
retrieving an accuracy metric for the one of the end users; and,
adjusting the quantification based upon the retrieved accuracy.

11. The system of claim 9, wherein the computer program instructions are further enabled to perform:
receiving from the one of the end users an indication of a resolution of the prospective fault;
computing an actual impact of the prospective fault at a time of the resolution based upon an additional amount of time required to complete the one of the tasks; and,
setting the known past quantification as the additional amount of time.

12. The system of claim 9, wherein the computer program instructions are further enabled to perform:
receiving from the one of the end users an indication of a resolution of the prospective fault;
computing an actual impact of the prospective fault at a time of the resolution based upon an additional cost required to complete the one of the tasks; and,
setting the known past quantification as the additional cost.

13. The system of claim 9, wherein the computer program instructions are further enabled to perform:
receiving from the one of the end users an indication of a resolution of the prospective fault;
computing an actual impact of the prospective fault at a time of the resolution based upon an additional count of human resources required to complete the one of the tasks; and,
setting the known past quantification as the additional count of human resources.

14. A computing device comprising a non-transitory computer readable storage medium having program instructions stored therein, the instructions being executable by at least one processing core of a processing unit to cause the processing unit to perform a method for prospective fault adaptation for project management, the method including:
generating a project in a project management system according to a timeline of different overlapping tasks, a cost to completion and a count of human resources required to complete the tasks at or below the cost to completion;
receiving an indication of a prospective fault condition in connection with one of the tasks in the project;
quantifying the prospective fault and computing an adjustment to one of the timeline, cost to completion and count of human resources in consequence of the prospective fault;
comparing the adjustment to a threshold value indicative of an acceptable project outcome; and,
generating a visualization of the project in the project management system including a flag representative of the prospective fault and including the comparison.

15. The computing device of claim 14, wherein the method further comprises:
comparing the quantification of the prospective fault with a known past quantification; and,
adjusting the quantification to be consistent with the known past quantification.

16. The computing device of claim 14, wherein the method further comprises:
retrieving an accuracy metric for the one of the end users; and,
adjusting the quantification based upon the retrieved accuracy.

17. The computing device of claim 15, wherein the method further comprises:
receiving from the one of the end users an indication of a resolution of the prospective fault;
computing an actual impact of the prospective fault at a time of the resolution based upon an additional amount of time required to complete the one of the tasks; and,
setting the known past quantification as the additional amount of time.

18. The computing device of claim 15, wherein the method further comprises:
receiving from the one of the end users an indication of a resolution of the prospective fault;
computing an actual impact of the prospective fault at a time of the resolution based upon an additional cost required to complete the one of the tasks; and,
setting the known past quantification as the additional cost.

19. The computing device of claim 15, wherein the method further comprises:
receiving from the one of the end users an indication of a resolution of the prospective fault;
computing an actual impact of the prospective fault at a time of the resolution based upon an additional count of human resources required to complete the one of the tasks; and,
setting the known past quantification as the additional count of human resources.

20. The computing device of claim 15, wherein the method further comprises:
receiving from the one of the end users an indication of a resolution of the prospective fault;
computing an actual impact of the prospective fault at a time of the resolution based upon a change in composition of a corresponding scope of the project; and,
setting the known past quantification as the change in the scope of the project.
